(19) United States
(12) Patent Application Publication
(10) Pub. No.: US 2026/0360245 A1
(43) Pub. Date: Nov. 12, 2026

(54) SYSTEM AND METHOD FOR ADAPTIVE ORCHESTRATION OF RESPONSIVE OUTPUTS BASED ON DYNAMIC MOVEMENT STATES

(71) Applicant: Amy Jo Lambert, East Peoria, IL (US)

(72) Inventor: Amy Jo Lambert, East Peoria, IL (US)

(21) Appl. No.: 19/672,618

(22) Filed: May 9, 2026

Related U.S. Application Data
(60) Provisional application No. 63/803,771, filed on May 11, 2025.
(60) Provisional application No. 63/803,781, filed on May 11, 2025.

(51) Int. Cl. G08B 21/04; G06V 20/52

(52) U.S. Cl. CPC G08B 21/0476; G06V 20/52

(57) ABSTRACT

A system and method for adaptive orchestration of responsive outputs based on dynamic movement states are disclosed. User-state data comprising motion data is segmented into sequential temporal windows. For each temporal window, a feature vector is generated from motion features. A movement-state label and confidence value are determined by comparing relationships among the features within or across temporal windows. The movement-state label and confidence value are updated over time to generate a movement-state trajectory. An adaptive response-state data object is generated based on the movement-state label, confidence value and trajectory. Output devices are selected using a device registry and controlled according to output-control parameters. A post-output movement state is determined from subsequent user-state data and compared with a pre-output movement state to modify future output-control parameters.

### CROSS-REFERENCE TO RELATED APPLICATIONS

This application claims priority to and the benefit of U.S. Provisional Patent Application No. 63/803,781, filed May 11, 2025, titled EverJourney: System AI for Real-Time Adaptive Orchestration of Narrative Wellness Experiences, the entire contents of which are incorporated herein by reference to the extent supported therein.

This application also claims priority to and the benefit of U.S. Provisional Patent Application No. 63/803,771, filed May 11, 2025, titled Poemme: Gracefulness Measurement and Emotionally-Responsive Narrative System, the entire contents of which are incorporated herein by reference to the extent supported therein.

### FIELD OF THE INVENTION

The present disclosure relates generally to adaptive response systems and, more particularly, to systems and methods for determining dynamic movement states from sensed user data, tracking changes in movement state over time and orchestrating responsive outputs across one or more devices, interfaces, environments or content systems based on movement-state trajectories and post-output state changes.

### BACKGROUND

Wearable devices, mobile devices, camera-based systems and environmental sensors are increasingly capable of capturing data relating to human movement. Conventional systems commonly process such data to generate isolated metrics, such as step counts, activity levels, heart rate, calories burned or basic exercise classifications. While such metrics may be useful, they often fail to characterize evolving qualitative aspects of movement over time, including coordination, steadiness, rhythm, coherence, control, fluidity or changes in movement quality.

Existing feedback systems also tend to generate outputs based on discrete events or static thresholds. For example, a device may vibrate when a target is reached, display a score after an exercise session or issue a warning when a measured value crosses a threshold. Such systems may not maintain a dynamic movement-state trajectory that reflects how a user's movement is evolving across sequential temporal windows or across multiple sessions.

Existing systems also often treat output generation as a simple alert or display function rather than as a technical orchestration problem. A user's changing movement state may drive coordinated responses across multiple output systems, including haptic devices, mobile interfaces, audio systems, visual displays, augmented reality systems, projection systems, environmental controls, narrative content systems, caregiver interfaces or authorized reviewer interfaces. However, conventional systems generally lack an orchestration layer configured to receive dynamic movement-state data, generate confidence-gated adaptive response-state data objects, route output commands to available devices and modify future output-control parameters based on post-output movement-state changes.

Accordingly, a need exists for improved systems and methods that determine movement states from relationships among sensed features, update movement-state trajectories over time, select responsive outputs using adaptive response-state data objects and adapt future outputs based on measured post-output state changes.

### SUMMARY

In one aspect, a system is provided for adaptive orchestration of responsive outputs based on dynamic movement states. The system includes one or more input devices configured to capture user-state data associated with a user. The user-state data may include motion data and may further include biometric data, contextual data, environmental data, user-entered data, historical data or combinations thereof.

A processing layer is configured to process the user-state data by filtering, normalizing, synchronizing or segmenting the data into sequential temporal windows. For each temporal window, the processing layer may generate a feature vector comprising one or more motion features, including acceleration variance, angular velocity magnitude, jerk-derived smoothness, periodicity, sway, cadence, range of motion or combinations thereof.

A state determination layer is configured to determine a movement-state label and an associated confidence value based at least in part on relationships among features within a temporal window or across sequential temporal windows. The movement-state label may represent, for example, stable movement, unstable movement, fluent movement, hesitant movement, fatigued movement, recovering movement, disrupted movement or sustained target movement. A temporal state management layer is configured to update the movement-state label and confidence value over time to form a movement-state trajectory.

An orchestration engine is configured to generate an adaptive response-state data object based at least in part on the movement-state label, confidence value, movement-state trajectory, historical user data, output history, contextual data or combinations thereof. The adaptive response-state data object may include one or more output-control parameters, including an output modality identifier, output device identifier, timing value, intensity value, duration value, sequence value, content identifier, priority value, escalation level or suppression condition.

An output control layer is configured to select and control one or more output devices based on the adaptive response-state data object. In some embodiments, the output control layer selects output devices using a device registry comprising device availability, output modality, latency, priority or user preference. Responsive outputs may include haptic output, audio output, visual output, display output, mobile application guidance, projected content, augmented reality content, environmental modulation, narrative content, caregiver notification, movement-state summary or combinations thereof.

In some embodiments, the system operates in a closed-loop manner. The system may store a pre-output movement state before generating a responsive output and determine a post-output movement state from subsequent user-state data after a predetermined time interval. The system may compare the pre-output movement state with the post-output movement state to classify a response effect, including improvement, stabilization, decline, no change or unknown effect. The system may modify a future output-control parameter based on the response effect.

In some embodiments, the system provides movement-instability support, session-to-session movement trend tracking, ambient environmental orchestration, narrative branching, movement-state summaries for authorized reviewers or non-wearable sensing embodiments. The system may provide movement-state indicators, wellness-oriented guidance, adaptive feedback, caregiver notifications or movement-related trend data. In some embodiments, the system does not itself generate a medical diagnosis, prescribe treatment or determine clinical necessity.

### BRIEF DESCRIPTION OF THE DRAWINGS

FIG. 1 illustrates an example system architecture for adaptive orchestration of responsive outputs based on dynamic movement states.

FIG. 2 illustrates an example movement-state trajectory over time and adaptive modification of responsive outputs based on changes in movement state.

FIG. 3 illustrates an example method flow for receiving user-state data, processing the data, extracting features, determining movement state, updating temporal state, selecting responsive outputs and adapting future outputs.

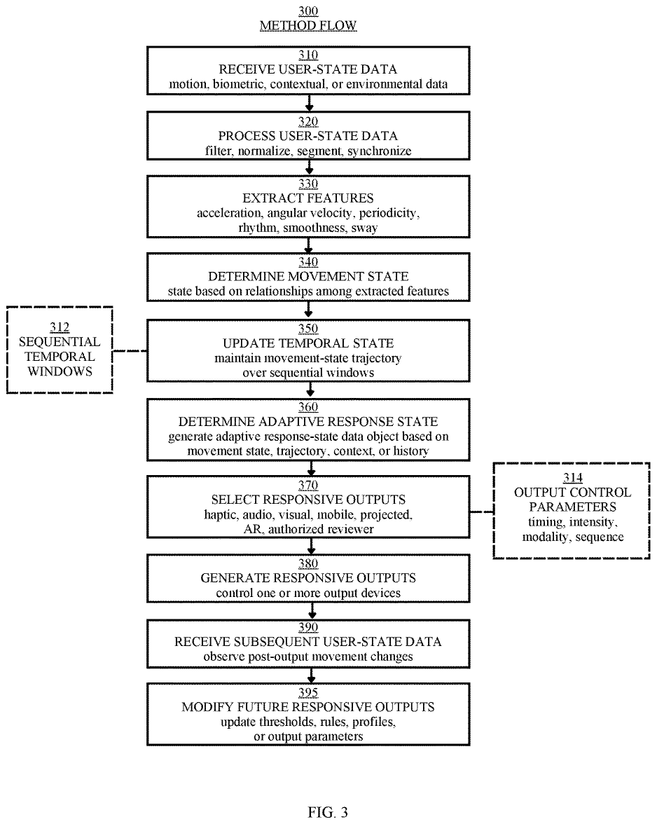

FIG. 4 illustrates an example multimodal output orchestration system configured to coordinate haptic, visual, audio, mobile, environmental, augmented reality, projection, narrative and reviewer outputs.

FIG. 5 illustrates an example closed-loop feedback system in which responsive outputs influence user movement and subsequent sensor data is used to update movement states and future responsive outputs.

FIG. 6 illustrates an example movement-instability escalation embodiment in which notification or response outputs are selected or escalated based on instability severity, persistence, confidence values or user context.

FIG. 7 illustrates an example recovery progression embodiment in which movement-state trajectories are compared across multiple sessions and guidance is adapted based on session-level trends.

### DETAILED DESCRIPTION

The following description sets forth example embodiments of systems and methods for adaptive orchestration of responsive outputs based on dynamic movement states. The described embodiments are illustrative and are not intended to limit the scope of the claimed invention. Features described in connection with one embodiment may be combined with features of other embodiments unless expressly stated otherwise.

As used herein, “user-state data” may include motion data, biometric data, contextual data, environmental data, user-entered data, interaction data, historical data or combinations thereof. As used herein, “movement state” may refer to a representation of user movement, including a label, score, vector, confidence-weighted state, structured data object or trajectory derived from sensed movement-related data.

As used herein, “adaptive response state” may refer to a system-generated data object or control state that defines how one or more responsive outputs should be selected, timed, routed, suppressed, escalated, reduced or modified. An adaptive response state may include an output modality, output device identifier, timing value, intensity value, duration value, content identifier, sequence value, priority value, escalation level, confidence threshold or suppression condition.

As used herein, “movement-state trajectory” may refer to a time-based sequence of movement-state labels, scores, vectors, confidence values or other state representations across sequential temporal windows or across sessions. A movement-state trajectory may indicate improvement, decline, stabilization, instability, fluency, hesitation, fatigue, sustained target movement or another movement-related pattern.

### 1. System Overview

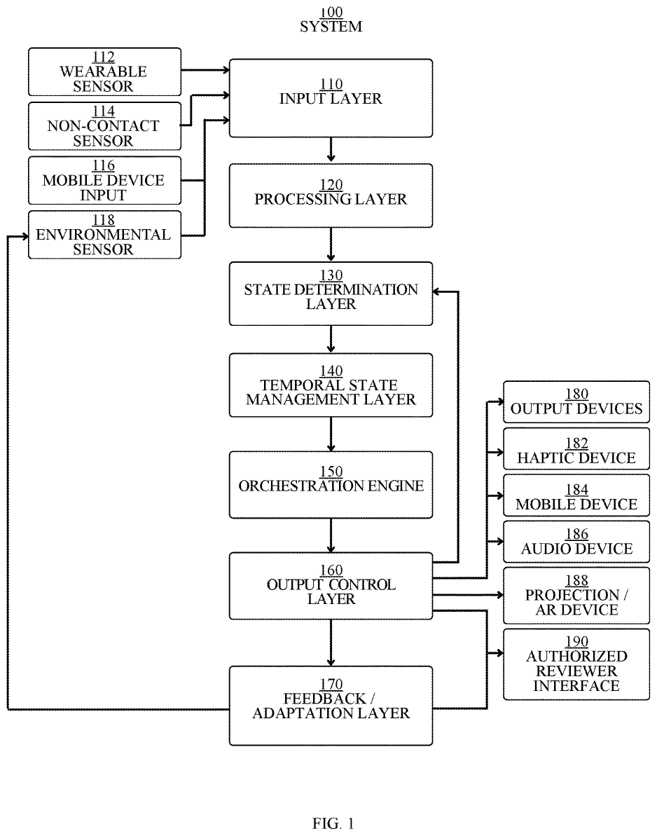

As shown in FIG. 1, an example system 100 may include an input layer 110, a processing layer 120, a state determination layer 130, a temporal state management layer 140, an orchestration engine 150, an output control layer 160 and a feedback or adaptation layer 170.

The input layer 110 is configured to receive user-state data associated with a user. In some embodiments, input layer 110 receives data from a wearable sensor 112, non-contact sensor 114, mobile device input 116, environmental sensor 118 or combinations thereof. Motion data may include data captured by accelerometers, gyroscopes, magnetometers, inertial measurement units, pressure sensors, force sensors, camera-based systems, depth sensors, radar sensors, lidar sensors, environmental sensors or other contact-based or non-contact sensing systems.

The processing layer 120 is configured to filter, normalize, segment, synchronize or otherwise process the user-state data. In some embodiments, motion data is segmented into sequential temporal windows. The temporal windows may be fixed, variable, overlapping, non-overlapping, event-triggered, activity-dependent or user-specific.

The state determination layer 130 is configured to extract or receive features from the user-state data and determine a movement-state label and confidence value based at least in part on the extracted features. Motion features may include acceleration magnitude, angular velocity, angular momentum, velocity, jerk, sway, periodicity, rhythm, symmetry, smoothness, tremor, cadence, range of motion, directional change, posture, balance, variance, stability, transition timing, gesture regularity, phase relationships or combinations thereof. Biometric features may include heart rate, heart rate variability, respiration, skin temperature, galvanic skin response, oxygen saturation or other physiological data.

In some embodiments, the movement-state label is determined based on relationships among features rather than isolated feature values. For example, a movement-state label may be determined based on relationships between acceleration variance and rotational velocity, rhythm and symmetry, jerk and stability, cadence and heart rate variability or motion coherence and user-entered context.

The temporal state management layer 140 is configured to update the movement-state label and confidence value over time. A series of movement states may form a movement-state trajectory. The movement-state trajectory may be used by the orchestration engine 150 to generate an adaptive response-state data object.

The orchestration engine 150 is configured to determine how the system should respond to the movement state. The orchestration engine 150 may receive a current movement-state label, prior movement-state labels, a movement-state trajectory, confidence values, contextual data, biometric data, historical data and output history. Based on such information, the orchestration engine 150 may generate an adaptive response-state data object.

In some embodiments, the orchestration engine selects and modifies responsive outputs by generating an adaptive response-state data object based on the current movement-state label, confidence value, movement-state trajectory, user context, historical response data and available output devices.

The orchestration engine may receive, as input, a movement-state data object comprising a movement-state label, confidence value, feature vector, temporal window identifier and trajectory identifier. The orchestration engine may compare the movement-state label and confidence value against one or more response-selection rules stored in memory. Each response-selection rule may define one or more trigger conditions and one or more output-control parameters.

In one embodiment, a response-selection rule includes (a) a triggering movement-state label; (b) a minimum confidence value; (c) a trajectory condition; (d) a context condition; (e) a selected output modality; (f) a selected output device or device class; (g) an output timing value; (h) an output intensity value; (i) an output duration value; (j) an output sequence value; and (k) a suppression condition.

For example, if the movement-state label is UNSTABLE, the confidence value exceeds a first threshold and the movement-state trajectory indicates increasing instability across sequential temporal windows, the orchestration engine may select a low-latency haptic output and generate an adaptive response-state data object specifying a haptic modality, wearable output device, immediate timing value, first intensity value and short duration value. If the unstable movement state persists for a predetermined number of temporal windows or increases in severity, the orchestration engine may modify the adaptive response-state data object to increase haptic intensity, add a mobile application prompt or generate a caregiver notification.

In another example, if the movement-state label is FLUENT, the confidence value exceeds a second threshold and the movement-state trajectory indicates sustained fluent movement across a predetermined number of temporal windows, the orchestration engine may select a reinforcement output. The reinforcement output may include a haptic confirmation, visual progression, audio cue, narrative content identifier or environmental output parameter. If the fluent movement state continues, the orchestration engine may reduce corrective prompts and increase reinforcement outputs.

In some embodiments, the orchestration engine selects output devices using a device registry. The device registry may include, for each output device, a device identifier, device class, output modality, availability value, latency value, priority value, user preference value and communication status. The orchestration engine may select a device based on the output modality specified by the adaptive response-state data object and may prefer devices having lower latency, higher priority or higher historical response effectiveness for the user.

In some embodiments, the orchestration engine modifies outputs by changing one or more output-control parameters in the adaptive response-state data object. The output-control parameters may include timing, intensity, frequency, duration, modality, device routing, sequence, content identifier, escalation level, suppression condition or synchronization value.

In some embodiments, the orchestration engine suppresses, delays or reduces a responsive output when the confidence value associated with the movement-state label is below a threshold. For example, when the confidence value is below a first threshold, the orchestration engine may suppress output generation. When the confidence value is between the first threshold and a second threshold, the orchestration engine may generate a reduced-intensity output. When the confidence value exceeds the second threshold, the orchestration engine may generate the selected responsive output according to the adaptive response-state data object.

In some embodiments, the orchestration engine modifies future responsive outputs based on a comparison between a pre-output movement state and a post-output movement state. The system may store a pre-output movement-state label and confidence value before generating a responsive output. After a predetermined time interval, the system may determine a post-output movement-state label and confidence value from subsequent user-state data. The orchestration engine may classify the response effect as improved, stabilized, declined, no change or unknown. Based on the response effect, the orchestration engine may update a threshold, rule priority, output modality, output intensity, output timing, device preference or user-specific profile.

For example, if a haptic output is associated with an improved post-output movement state across multiple similar events, the orchestration engine may increase the priority of haptic output for similar future movement states. If a visual output is associated with a declined or unstable post-output movement state across multiple similar events, the orchestration engine may reduce visual output intensity, delay visual output, suppress visual output or select another modality for similar future movement states.

In some embodiments, the orchestration engine may use a response-selection table stored in memory. The response-selection table may map movement-state labels, confidence ranges, trajectory conditions and context values to output-control parameters. In some embodiments, the response-selection table may be updated based on session history, user feedback, post-output movement-state comparison or authorized reviewer input.

The output control layer 160 is configured to generate, modify or coordinate responsive outputs through one or more output devices 180. Output devices 180 may include a haptic device 182, mobile device 184, audio device 186, projection or augmented reality device 188, caregiver or authorized reviewer interface 190 or combinations thereof. The feedback or adaptation layer 170 is configured to receive subsequent user-state data after outputs are generated and modify future output-control parameters based on post-output movement-state changes.

### 2. Feature Extraction

In some embodiments, the processing layer 120 may calculate an acceleration magnitude or acceleration-derived feature from acceleration values along multiple axes. For example, and without limitation, the acceleration-derived feature may be based on a square root of a sum of squared acceleration components, a normalized magnitude, a filtered magnitude, a rolling average, a variance, a peak-to-peak value or another representation of multi-axis acceleration.

In some embodiments, the processing layer 120 may calculate acceleration variance or another variability feature over a temporal window W. The variability feature may be based on variance, standard deviation, mean absolute deviation, range, entropy, peak-to-peak change or another measure of variation within the temporal window.

In some embodiments, the processing layer 120 may calculate angular velocity magnitude or another rotational-motion feature from gyroscope data. The rotational-motion feature may be based on one or more axes of angular velocity, a combined rotational magnitude, a filtered rotational signal, a variance value, a peak value or another rotational feature.

In some embodiments, the processing layer 120 may calculate smoothness based on jerk or another rate-of-change measure. Jerk may be represented as a change in acceleration over time, and a smoothness feature may be based on average jerk, absolute jerk, integrated jerk, normalized jerk, spectral smoothness, path regularity or another measure of movement continuity.

The processing layer 120 may calculate periodicity by identifying repeating movement patterns within a temporal window. For example, and without limitation, periodicity may be based on autocorrelation, frequency-domain analysis, peak spacing, cadence regularity, cycle consistency or another measure indicating repeated or rhythmic movement.

The processing layer 120 may calculate symmetry by comparing corresponding movement features across cycles, sides of the body or repeated gestures. For example, and without limitation, symmetry may be based on normalized differences between repeated movement cycles, left-right feature comparisons, temporal alignment between movement phases, amplitude similarity, cadence similarity or another measure of correspondence between movement features.

In some embodiments, the processing layer 120 generates a feature vector for each temporal window. The feature vector may include any combination of acceleration-derived features, rotational-motion features, smoothness features, periodicity features, symmetry features, cadence features, sway features, range-of-motion features, biometric features, contextual features or environmental features. The feature vector may be normalized against a user-specific baseline, population reference values or session-specific calibration data.

In some embodiments, the processing layer 120 removes samples with invalid timestamps, applies low-pass filtering to reduce high-frequency noise, applies drift correction where needed, synchronizes data from one or more sensors, segments data into temporal windows, calculates motion features for each temporal window, assembles a feature vector and outputs the feature vector to the state determination layer 130.

### 3. State Determination and State Transitions

The state determination layer 130 may determine a movement-state label and confidence value using rules, thresholds, statistical models, machine learning models, neural networks, decision trees, support vector machines, hidden Markov models, recurrent models, temporal convolution models or combinations thereof.

Movement-state labels may include stable, unstable, fluent, hesitant, fatigued, recovering, disrupted and sustained target state. These labels are examples only. Other movement-state labels, scores, vectors or state representations may be used.

In some embodiments, a state transition may occur based on changes in feature values across one or more temporal windows. For example, and without limitation, the state determination layer 130 may determine that a movement state is fluent when smoothness increases across multiple temporal windows, acceleration variance decreases and periodicity increases. The particular thresholds, weighting values and window counts used to determine the transition may be fixed, user-specific, session-specific, learned or adaptively updated.

In some embodiments, the state determination layer 130 may determine that a movement state is unstable when sway, jerk, directional irregularity, posture deviation, reduced cadence consistency or other instability-related features exceed one or more thresholds. The state determination layer 130 may also consider a confidence value, signal quality, sensor agreement or temporal persistence before assigning an unstable movement-state label.

In some embodiments, a sustained target state may be detected when a target movement-state label persists across a predetermined number of temporal windows or when one or more movement-state scores remain within a target range for a predetermined duration. The target movement state may be stable, fluent, coordinated, recovering, sustained target state or another state selected for a user, activity, session or application.

In some embodiments, a recovery transition may be detected when movement-state data indicates a transition from unstable, hesitant, disrupted or fatigued movement toward steadier, smoother, more fluent or more coordinated movement over a sequence of temporal windows. The term recovery transition in this context refers to a movement-state trend and not to a medical diagnosis or determination of clinical recovery.

### 4. Confidence Values and Confidence-Gated Outputs

In some embodiments, the state determination layer 130 assigns a confidence value to a movement-state label. The confidence value may be based on feature strength, sensor quality, consistency across temporal windows, agreement among models, agreement among sensor modalities, temporal persistence, data completeness or combinations thereof.

In some embodiments, the confidence value may be computed using a weighted combination of one or more confidence factors. For example, and without limitation, the confidence value may be based on model probability, feature consistency, signal quality, temporal persistence and sensor agreement. Different weights may be used for different users, devices, sessions, activities, movement states or operating contexts.

Feature consistency may represent whether extracted features support the same movement-state label across multiple temporal windows. Signal quality may be based on missing data, noise level, sensor orientation reliability, sampling consistency or communication stability. Temporal persistence may represent whether the same movement-state label persists long enough to reduce false triggering. Sensor agreement may represent whether motion data, biometric data, environmental data or non-contact sensor data support the same movement-state determination.

In some embodiments, responsive outputs are suppressed, delayed, reduced in intensity, modified in modality or routed to a different output device when the confidence value is below a threshold. For example, when the confidence value is below a first threshold, the system may suppress output generation. When the confidence value is between the first threshold and a second threshold, the system may generate a reduced-intensity output, delay the output or select a lower-intrusion modality. When the confidence value exceeds the second threshold, the system may generate the selected responsive output according to the adaptive response-state data object.

In some embodiments, confidence thresholds may be fixed, user-specific, session-specific, activity-specific, device-specific or adaptively updated based on historical response effectiveness, user feedback, authorized reviewer input, post-output movement-state comparisons or combinations thereof.

### 5. Temporal State Management

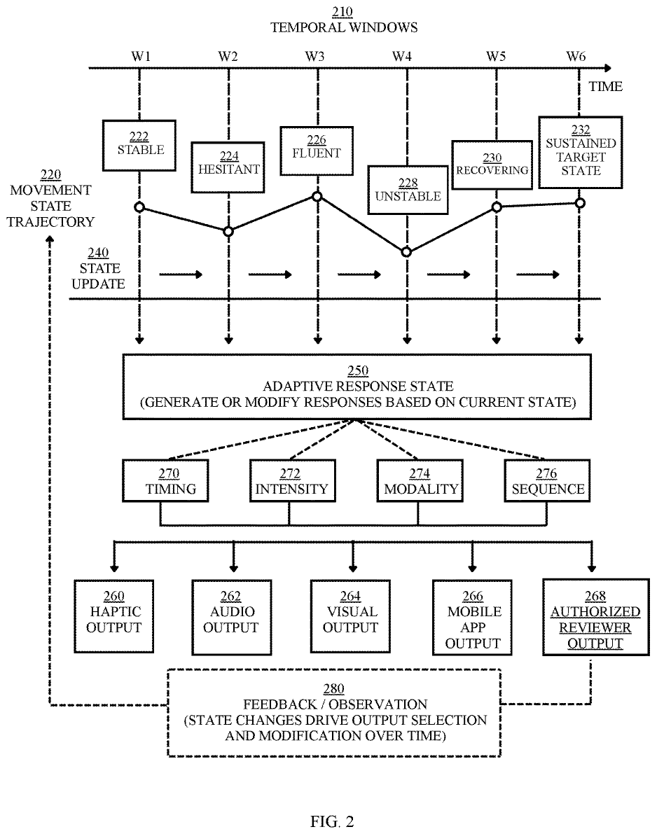

As shown in FIG. 2, sequential temporal windows 210 may be used to update a movement-state trajectory 220. Example movement-state labels may include stable state 222, hesitant state 224, fluent state 226, unstable state 228, recovering state 230 and sustained target state 232. A state update process 240 may update the movement-state trajectory 220 across temporal windows W1 through W6.

The temporal state management layer 140 may apply smoothing, hysteresis, confidence thresholds, persistence criteria, cooldown periods or suppression rules to avoid abrupt or inappropriate output changes. For example, the system may require that a candidate movement-state label persist for a predetermined number of temporal windows before updating the current movement-state label or generating a responsive output.

In some embodiments, the temporal state management layer 140 applies smoothing to reduce rapid oscillation between movement states. Smoothing may be performed using an exponential moving average, rolling average, median filter, weighted temporal filter, state probability smoothing, trajectory-level smoothing or another technique that reduces noise or abrupt state changes.

In some embodiments, hysteresis is applied so that entry into a movement-state label and exit from the movement-state label use different thresholds. For example, the system may enter a fluent state when a smoothness score satisfies a first threshold and exit the fluent state when the smoothness score falls below a second threshold. The first and second thresholds may differ to reduce rapid switching between movement-state labels.

In some embodiments, the temporal state management layer 140 uses cooldown periods or suppression rules. For example, if an output has been generated within a preceding interval, the system may suppress a duplicate output unless instability severity, temporal persistence, confidence value, user context or another condition justifies generating an additional output.

In some embodiments, the temporal state management layer 140 maintains a movement-state trajectory comprising a sequence of movement-state labels, confidence values, feature vectors, state scores, timestamps, temporal window identifiers or combinations thereof. The movement-state trajectory may be stored in memory and provided to the orchestration engine 150.

In some embodiments, the movement-state trajectory may be used to detect patterns across time, including improvement, decline, stabilization, increased instability, increased fluency, reduced hesitation, increased fatigue, sustained target movement, interrupted movement or another time-based movement pattern.

In some embodiments, the temporal state management layer 140 may compare a current movement-state trajectory with one or more prior movement-state trajectories. The comparison may be used to update a user-specific threshold, movement-session trend indicator, adaptive response-state data object, guidance level, output frequency, output intensity, output modality or future output-control parameter.

### 6. Orchestration Engine and Adaptive Response-State Data Object

The orchestration engine 150 may generate an adaptive response-state data object 250 based on one or more movement-state labels, changes in movement-state labels, a movement-state trajectory, confidence values, thresholds, historical patterns, prior outputs, user feedback, environmental context, biometric data or combinations thereof.

The adaptive response-state data object 250 may specify one or more output-control parameters, including timing 270, intensity 272, modality 274, sequence 276, output duration, content identifier, device identifier, priority value, escalation level or suppression condition. The adaptive response-state data object may be stored in memory and provided to the output control layer 160.

In some embodiments, the orchestration engine 150 selects an output-control parameter set associated with a target movement-state transition. For example, when a user is in an unstable state with a high confidence value, the orchestration engine 150 may select a stabilization cue. When a user has sustained a target state for a predetermined duration, the orchestration engine 150 may select a reinforcement cue, narrative content identifier or reduced-intrusion output.

In some embodiments, the orchestration engine 150 selects outputs associated in stored output history with measured post-output movement-state changes. For example, if haptic outputs have repeatedly been associated with improvement or stabilization for a particular user under stored comparison criteria, the orchestration engine 150 may increase the priority of haptic outputs for similar future movement-state trajectories.

### 7. Output Control Layer and Device Coordination

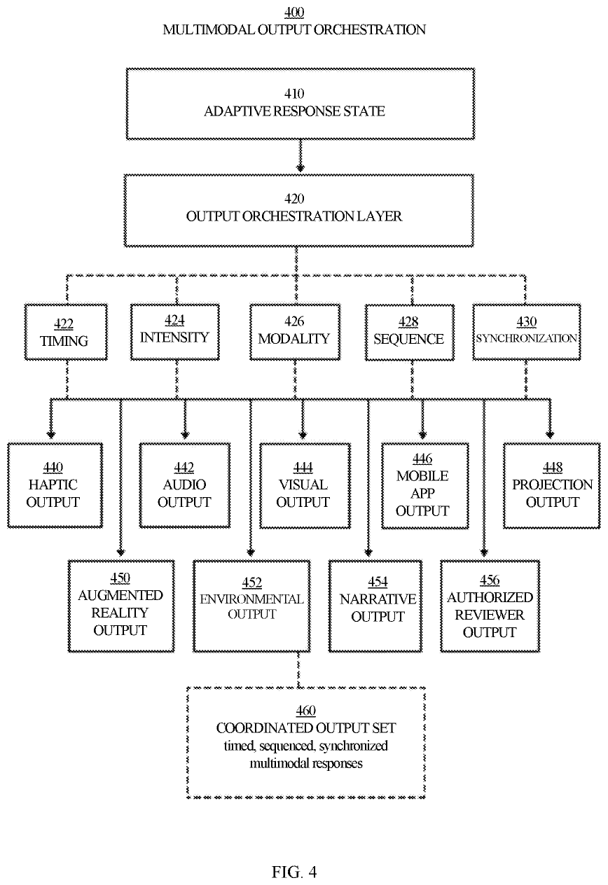

As shown in FIG. 4, a multimodal output orchestration system 400 may receive an adaptive response state 410 and provide the adaptive response state 410 to an output orchestration layer 420. The output orchestration layer 420 may determine output-control parameters including timing 422, intensity 424, modality 426, sequence 428 and synchronization 430.

The output control layer 160 may control one or more output devices or systems, including haptic output 440, audio output 442, visual output 444, mobile application output 446, projection output 448, augmented reality output 450, environmental output 452, narrative output 454, caregiver or authorized reviewer output 456 and coordinated output set 460.

In some embodiments, the output control layer 160 selects output devices using a device registry. The device registry may include device identifiers, output modalities, availability values, latency values, priority values, battery status, network status, user preferences or suppression rules.

```
DeviceRegistry = [
  {device_id: “wearable_001”, modality: “haptic”,
  available: true, latency_ms: 40, priority:
high},
  {device_id: “mobile_001”, modality: “visual_display”,
  available: true, latency_ms: 120,
priority: medium},
  {device_id: “speaker_001”, modality: “audio”,
  available: true, latency_ms: 180, priority:
medium}
]
```

In some embodiments, the output control layer 160 receives an adaptive response-state data object, identifies required output modalities, queries available output devices, ranks devices by availability, latency, priority or user preference, assigns output instructions to selected devices, synchronizes outputs using timestamps or sequence identifiers, sends output commands to selected devices and records an output event in output history.

For example, when a movement-instability state is detected with a high confidence value, the output control layer 160 may send a haptic pulse immediately, delay a visual prompt by a predetermined interval and suppress projected content. In another example, when a sustained target state is detected, the output control layer 160 may trigger an audio transition, update a mobile display, advance projected content if a projector is available and record the event in session history.

### 8. Closed-Loop Feedback and Post-Output Comparison

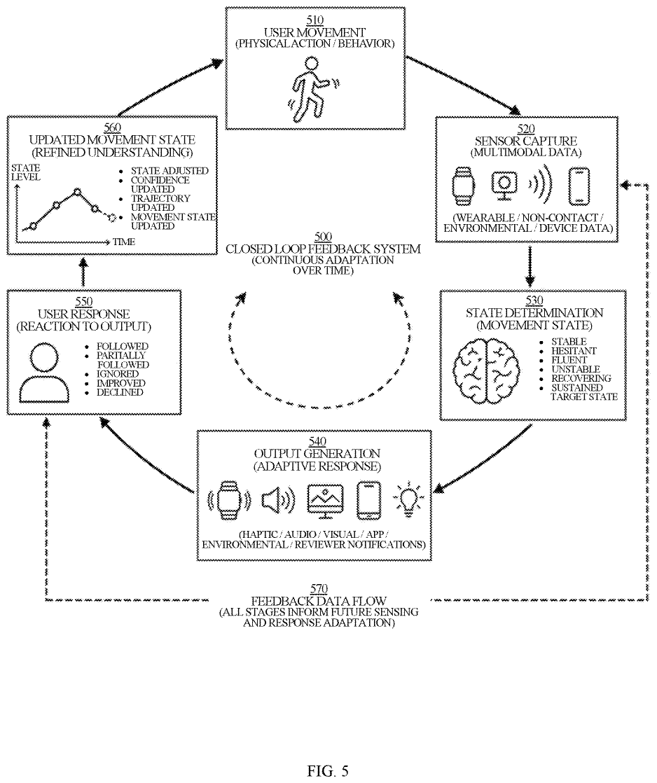

As shown in FIG. 5, a closed-loop feedback system 500 may include user movement 510, sensor capture 520, state determination 530, output generation 540, user response 550, updated movement state 560 and feedback data flow 570. The system may determine whether a responsive output was associated with a measured post-output movement-state change.

In some embodiments, the system stores a pre-output movement state before a responsive output is generated. After a predetermined time interval, the system receives subsequent user-state data, determines a post-output movement state and compares the pre-output movement state with the post-output movement state. The system may classify a response effect as improved, stabilized, declined, no change or unknown.
pre_output_state=movement_state at time T
generate responsive output at time T
post_output_state=movement_state at time T+delta
response_effect=compare(pre_output_state, post_output_state)

If the pre-output movement state is unstable and the post-output movement state is stable, the response effect may be classified as improved. If the pre-output movement state is fluent and the post-output movement state remains fluent for a predetermined number of temporal windows, the response effect may be classified as stabilized. If the post-output state confidence is below a minimum confidence threshold, the response effect may be classified as unknown.

The feedback or adaptation layer 170 may update response rules, thresholds, user profiles, model parameters or future output selections based on response effects. For example, if a particular output modality is associated with measured post-output movement-state improvement under stored comparison criteria, the system may increase the priority of that output modality for a similar future movement-state trajectory. If a particular output modality is associated with decline under stored comparison criteria, the system may reduce intensity or deprioritize that output modality.

### 9. User-specific Thresholding and Session History

In some embodiments, thresholds are not fixed across all users. The system may establish user-specific baselines during calibration, early sessions or ongoing use. Example baseline values may include average sway, average jerk, average periodicity, average smoothness and average session duration.

user_instability_threshold=average_sway+2*standard_deviation_sway

user_fluency_threshold=average_smoothness+improvement_margin

In some embodiments, a target sustained movement state may be detected when a user exceeds a user-specific baseline rather than a universal benchmark. For example, if a smoothness score exceeds a user baseline by an improvement margin and periodicity remains above the user baseline for a predetermined number of temporal windows, the system may assign a sustained target movement-state label.

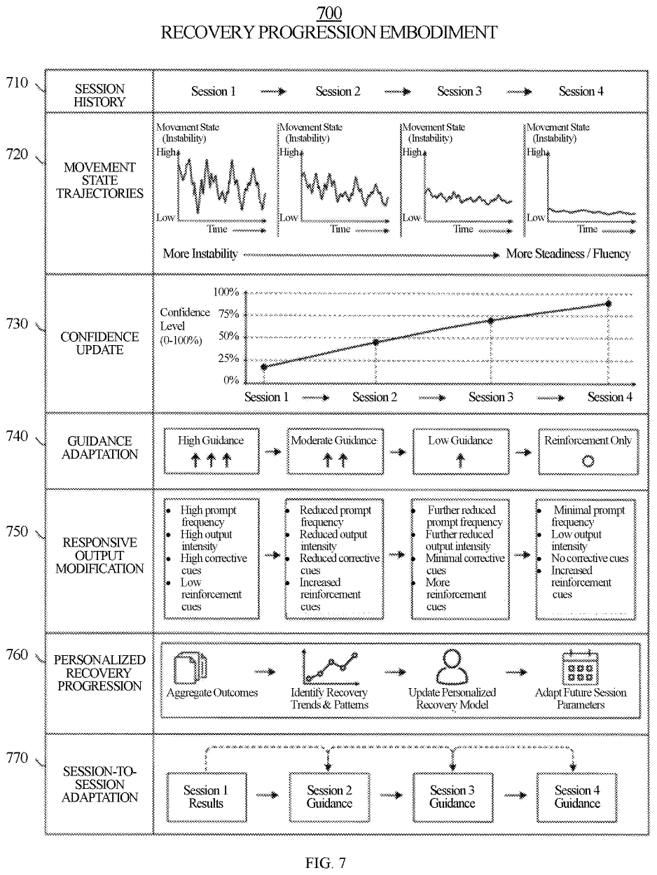

As shown in FIG. 7, a recovery progression embodiment 700 may include session history 710, movement-state trajectories 720, confidence update 730, guidance adaptation 740, responsive output modification 750, personalized recovery progression 760 and session-to-session adaptation 770. In this context, recovery progression refers to movement-session trends and does not by itself indicate a medical diagnosis, medical recovery determination or clinical necessity.

The system may store session-level movement-state trajectories and compare a current session trajectory with at least one prior session trajectory. The system may generate a movement-session trend indicator based on changes in stability, smoothness, periodicity, sustained target-state duration, confidence values, post-output response effects or output history across sessions.

In some embodiments, early sessions may include more frequent guidance when movement-state trajectories show greater instability, lower confidence or more frequent interruptions. Later sessions may include reduced prompt frequency, reduced output intensity, reduced corrective cues or increased reinforcement cues when movement-state trajectories show increased steadiness, fluency, persistence or confidence.

### 10. Machine Learning Model Training or Inference

In some embodiments, a machine learning model may be used to determine movement-state labels, adaptive response states or future output modifications. Training data may include motion feature vectors, biometric feature vectors, environmental context, user-entered feedback, authorized reviewer labels, historical movement-state labels, prior responsive outputs and post-output movement-state changes.

In a supervised training embodiment, an input feature vector may be associated with a movement-state label. A model may be trained to map the feature vector to the movement-state label. During inference, the system may provide a feature vector to a trained model that outputs movement-state probabilities. The system may select the movement-state label having a highest probability and store the probability as part of the confidence value. p1 F_W=current feature vector
movement_state_probability=model.predict(F_W)
movement_state=argmax(movement_state_probability)
confidence=max(movement_state_probability)

In some embodiments, adaptive response selection may use a response policy in which a state comprises a movement-state label, confidence value and context, an action comprises an output-control parameter set and a reward or update value is based on a classified post-output response effect. Safety-sensitive or high-priority outputs may be governed by rules or thresholds, while adaptive models may be used for personalization.

### 11. Data Structures

In some embodiments, the movement state may be stored as a data object comprising a user identifier, timestamp, movement-state label, state score, confidence value, feature vector, temporal window identifier, prior state label, trajectory identifier and source device identifier.

In some embodiments, the adaptive response state may be stored as a data object comprising a response state identifier, timestamp, triggering movement-state label, required confidence value, selected modalities, output timing, output intensity, output duration, output sequence, content identifier, suppression conditions and escalation level.

In some embodiments, output history may be stored as a data object comprising an output event identifier, user identifier, timestamp, adaptive response-state identifier, devices used, output modalities, output parameters, pre-output movement state, post-output movement state, response effect and user feedback.

In some embodiments, a user profile may be stored as a data object comprising baseline features, preferred output modalities, suppressed output modalities, adaptive thresholds and historical response effectiveness values.

### 12. Example Embodiments

In a wearable movement-state orchestration embodiment, a wearable sensing device captures motion data using an inertial measurement unit. The system processes the motion data to extract acceleration variance, rotational velocity, cadence, rhythm and smoothness. The state determination layer 130 determines a movement-state label and confidence value based on relationships among the extracted features. The temporal state management layer 140 updates the movement-state label over time. The orchestration engine 150 generates an adaptive response-state data object that causes a haptic actuator to provide feedback when movement state changes from stable to unstable or from hesitant to coordinated.

In a biometric and movement-state orchestration embodiment, a system receives motion data and biometric data, including heart rate, heart rate variability, skin temperature or galvanic skin response. The orchestration engine 150 determines an adaptive response-state data object based on both movement-state data and biometric data. For example, if movement becomes less coordinated while heart rate increases, the system may reduce prompt intensity, select a lower-intensity audio output or generate a mobile prompt encouraging a pause.

In a narrative feedback orchestration embodiment, a system determines that a user has sustained a target movement-state label for a predetermined duration. The orchestration engine 150 selects a narrative content identifier based on the sustained movement-state label, user profile and prior output history. The output control layer 160 causes selected narrative content to be delivered through a mobile device, speaker, projection system or augmented reality interface. The narrative content may branch, slow, intensify or shift based on subsequent changes in movement state.

In an environmental orchestration embodiment, a system controls environmental outputs, including lighting, projection, audio and display content. The orchestration engine 150 modifies environmental parameters based on a movement-state trajectory. For example, if movement becomes more fluent over time, the system may gradually increase visual motion, adjust audio tempo or transition projected content. If movement becomes unstable, the system may reduce visual complexity, reduce audio intensity or provide stabilizing guidance.

In an authorized reviewer output embodiment, a system generates a movement-state summary of movement-state trajectories over multiple sessions. The summary may include movement-state labels, confidence values, event timing, output history, detected instability events, sustained target-state periods, response effects, session duration or movement-related trend data. The summary may be transmitted to a caregiver device, authorized reviewer interface or clinician-accessible interface without generating a diagnosis.

In a guided wellness session embodiment, a user engages in a guided session using movement-state feedback and user-entered context. The system receives movement data, biometric data and user-entered context. The system determines movement-state labels over time and orchestrates haptic cues, audio prompts, visual content and journaling prompts based on the evolving movement state. After the session, the system stores trajectory data and user feedback to adapt future sessions.

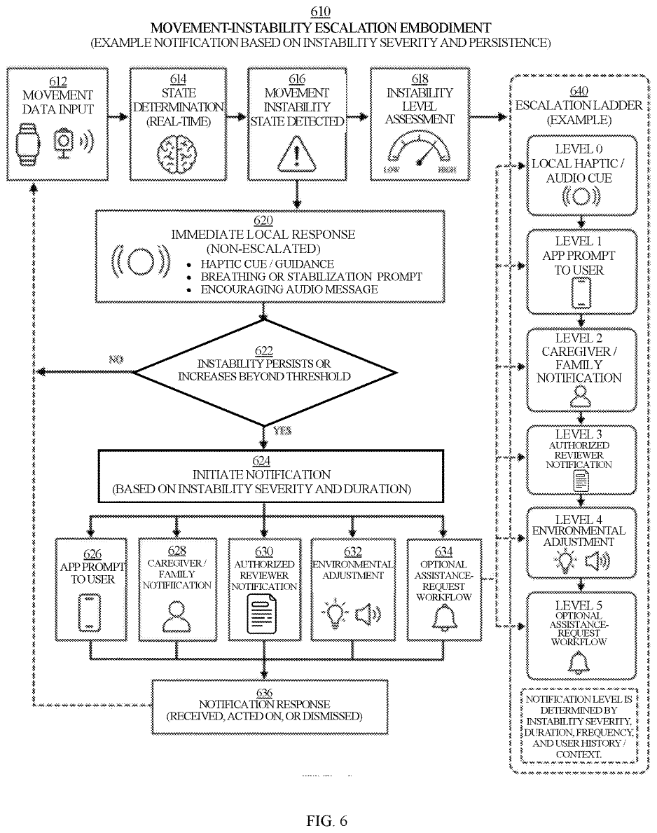

As shown in FIG. 6, in a movement-instability escalation embodiment 610, the system may receive movement data input 612, perform real-time state determination 614, detect an unstable or movement-instability state 616 and perform an instability level assessment 618. The term instability level in this embodiment refers to a system-level movement-instability severity or persistence value and not to a medical diagnosis or prediction of injury.

The movement-instability escalation embodiment 610 may generate an immediate local response 620, determine whether an instability condition persists or increases beyond a threshold 622 and initiate notification 624 based on instability severity and duration. Notification outputs may include app prompt 626, caregiver or family notification 628, authorized reviewer notification 630, environmental adjustment 632, optional assistance-request workflow 634 or notification response logging 636. An escalation ladder 640 may define levels of output based on instability severity, duration, frequency, confidence value or user context.

In a no-wearable embodiment, the system determines movement state without requiring a wearable device. The input layer 110 may include one or more non-contact sensors, including a camera, depth camera, radar sensor, lidar sensor, pressure-sensitive floor, environmental motion sensor, room-based presence sensor or other sensor configured to capture user movement or position in a physical environment. The processing layer 120 may extract posture, sway, gait regularity, center-of-mass movement, step timing, body-segment motion, room position, transition speed, stillness, balance shift, reach pattern or directional change from non-contact sensor data. The same orchestration engine 150 may then select and coordinate responsive outputs using the adaptive orchestration framework described herein.

What is claimed is:

1. A system for adaptive orchestration of responsive outputs based on dynamic movement states, comprising:
one or more input devices configured to capture user-state data comprising motion data associated with a user;
one or more processors; and
one or more non-transitory computer-readable storage media storing instructions that, when executed by the one or more processors, cause the system to:
receive the user-state data;
segment the motion data into sequential temporal windows;
generate, for each temporal window, a feature vector comprising at least two motion features selected from acceleration variance, angular velocity magnitude, jerk-derived smoothness, periodicity, sway, cadence or range of motion;
determine a movement-state label and confidence value by comparing relationships among the motion features within a temporal window or across sequential temporal windows;
update the movement-state label and confidence value over time to generate a movement-state trajectory;
generate an adaptive response-state data object based at least in part on the movement-state label, the confidence value and the movement-state trajectory, the adaptive response-state data object comprising at least an output modality, output device identifier, timing value, intensity value, duration value or suppression condition;
select one or more output devices using a device registry comprising device availability, output modality, latency or priority;
control the one or more output devices to generate one or more responsive outputs according to the adaptive response-state data object;
determine a post-output movement state from subsequent user-state data after a predetermined time interval; and
compare a pre-output movement state with the post-output movement state and modify at least one future output-control parameter based on the comparison.

2. The system of claim 1, wherein the user-state data further comprises biometric data, environmental data, user-entered contextual data, user-entered emotional-context data, historical user data or combinations thereof.

3. The system of claim 1, wherein the one or more input devices comprise at least one wearable sensor, non-contact sensor, mobile device sensor, environmental sensor, camera-based sensor, depth sensor, radar sensor, lidar sensor, pressure-sensitive floor or room-based presence sensor.

4. The system of claim 1, wherein generating the feature vector comprises filtering, normalizing, synchronizing or processing motion data within the sequential temporal windows.

5. The system of claim 1, wherein the movement-state label comprises a label representing stable movement, unstable movement, fluent movement, hesitant movement, fatigued movement, recovering movement, disrupted movement or sustained target movement.

6. The system of claim 1, wherein the confidence value is based at least in part on model probability, feature consistency, signal quality, temporal persistence, sensor agreement or combinations thereof.

7. The system of claim 1, wherein the instructions further cause the system to suppress, delay or reduce intensity of a responsive output when the confidence value is below a threshold.

8. The system of claim 1, wherein the adaptive response-state data object further comprises output sequence, content identifier, priority value, escalation level, confidence threshold or device routing instruction.

9. The system of claim 1, wherein the one or more responsive outputs comprise haptic output, audio output, visual output, mobile application output, projected output, augmented reality output, environmental modulation, narrative output, caregiver notification or movement-state summary interface output.

10. The system of claim 1, wherein the one or more output devices comprise at least two output devices and wherein the instructions further cause the system to coordinate timing, sequencing, modality, synchronization or content of outputs across the at least two output devices.

11. The system of claim 1, wherein the device registry further comprises a device identifier, user preference, network status, battery status or suppression rule.

12. The system of claim 1, wherein the instructions further cause the system to maintain a historical user profile based on prior movement-state trajectories, prior responsive outputs, user feedback or prior post-output movement-state comparisons.

13. The system of claim 1, wherein the instructions further cause the system to store session-level movement-state trajectories and compare a current session trajectory with at least one prior session trajectory to generate a movement-session trend indicator.

14. The system of claim 1, wherein the instructions further cause the system to generate a movement-instability support output based on persistence, severity or confidence associated with an unstable movement-state label.

15. The system of claim 14, wherein the movement-instability support output comprises a haptic cue, mobile application prompt, caregiver notification, environmental adjustment, optional assistance-request notification or event-log entry.

16. A computer-implemented method for adaptive orchestration of responsive outputs based on dynamic movement states, comprising:
receiving, by one or more processors, user-state data comprising motion data associated with a user;
segmenting, by the one or more processors, the motion data into sequential temporal windows;
generating, by the one or more processors for each temporal window, a feature vector comprising at least two motion features selected from acceleration variance, angular velocity magnitude, jerk-derived smoothness, periodicity, sway, cadence or range of motion;
determining, by the one or more processors, a movement-state label and confidence value by comparing relationships among the motion features within a temporal window or across sequential temporal windows;
updating, by the one or more processors, the movement-state label and confidence value over time to generate a movement-state trajectory;
generating, by the one or more processors, an adaptive response-state data object based at least in part on the movement-state label, the confidence value and the movement-state trajectory, the adaptive response-state data object comprising at least an output modality, output device identifier, timing value, intensity value, duration value or suppression condition;
selecting, by the one or more processors, one or more output devices using a device registry comprising device availability, output modality, latency or priority;
causing, by the one or more processors, the one or more output devices to generate one or more responsive outputs according to the adaptive response-state data object;
determining, by the one or more processors, a post-output movement state from subsequent user-state data after a predetermined time interval; and
modifying, by the one or more processors, at least one future output-control parameter based on a comparison of a pre-output movement state with the post-output movement state.

17. The computer-implemented method of claim 16, wherein receiving the user-state data comprises receiving data from a wearable sensor, non-contact sensor, mobile device sensor, environmental sensor, camera-based sensor, depth sensor, radar sensor, lidar sensor, pressure-sensitive floor or room-based presence sensor.

18. The computer-implemented method of claim 16, wherein causing the one or more output devices to generate the one or more responsive outputs comprises coordinating haptic, audio, visual, mobile application, projected, augmented reality, environmental, narrative, caregiver or authorized reviewer interface outputs.

19. A non-transitory computer-readable storage medium storing instructions that, when executed by one or more processors, cause a system to perform operations comprising:
receiving user-state data comprising motion data associated with a user; segmenting the motion data into sequential temporal windows; generating, for each temporal window, a feature vector comprising at least two motion features selected from acceleration variance, angular velocity magnitude, jerk-derived smoothness, periodicity, sway, cadence or range of motion; determining a movement-state label and confidence value by comparing relationships among the motion features within a temporal window or across sequential temporal windows; updating the movement-state label and confidence value over time to generate a movement-state trajectory; generating an adaptive response-state data object based at least in part on the movement-state label, the confidence value and the movement-state trajectory, the adaptive response-state data object comprising at least an output modality, output device identifier, timing value, intensity value, duration value or suppression condition; selecting one or more output devices using a device registry comprising device availability, output modality, latency or priority; causing the one or more output devices to generate one or more responsive outputs according to the adaptive response-state data object; determining a post-output movement state from subsequent user-state data after a predetermined time interval; andmodifying at least one future output-control parameter based on a comparison of a pre-output movement state with the post-output movement state.

20. The non-transitory computer-readable storage medium of claim 19, wherein the operations further comprise maintaining a historical user profile, updating a threshold, updating a response rule, updating a model parameter, updating a device routing instruction or updating a future output-control parameter based on the comparison of the pre-output movement state with the post-output movement state.
